(19) United States
(12) Patent Application Publication
(10) Pub. No.: US 2007/0143547 A1
(43) Pub. Date: Jun. 21, 2007

(54) Predictive caching and lookup

(75) Inventors: Donald M. Farmer, Woodinville, WA (US); ZhaoHui Tang, Bellevue, WA (US); C. James MacLennan, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/312,271

(22) Filed: Dec. 20, 2005

(51) Int. Cl. G06F 12/00

(52) U.S. Cl. 711/137

(57) ABSTRACT

The subject disclosure pertains to systems and methods for data caching and/or lookup. A data-mining model can be employed to identify data item relationships, associations, and/or affinities. A cache or other fast memory can then be populated based on data mining information. A lookup component can interact with the memory to facilitate expeditious lookup or discovery of information, for example to aid data warehouse population, amongst other things.

### BACKGROUND

Cache is a type of fast memory that holds copies of original data that resides elsewhere such that it is more efficient in terms of processing time to read data from the cache than it is to fetch the original. The concept is to use fast often more expensive memory to offset a larger amount of slower often less expensive memory. During processing, a cache client can first query the cache for particular data. If the data is available in the cache, it is termed a cache hit, and the data can be retrieved from the cache. If the data is not resident in the cache, then it is termed a miss, and the cache client must retrieve the data from a slower medium such as a disk. The most popular applications of cache are for CPU (Central Processing Unit) and disk caching. More specifically, the cache bridges the speed gap between main memory (e.g., RAM) and CPU registers and between disks and main memory. Additionally, software managed caching also exists for example for caching web pages for a web browser.

Data integration or data transformation corresponds to a set of processes that facilitate capturing data from a myriad of different sources to enable entities to take advantage of the knowledge provided by the data as a whole. For example, data can be provided from such diverse sources as a CRM (Customer Relations Management) system, an ERP (Enterprise Resource Planning) system, and spreadsheets as well as sources of disparate formats such as binary, structured, semi-structured and un-structured. Accordingly, such sources are subjected to an extract, transform, and load (ELT) process to unify the data into a single format in the same location to facilitate useful analysis of such data. For example, such data can be loaded into a data warehouse.

In a data integration process, incoming records often need to be matched to existing records to return related values. For example, the process may lookup a product name from an incoming record against an existing product database as a reference. If a match is found, the product name is returned for use in the rest of the process.

The performance of such a process can be improved by caching potential matching values from the reference table in memory prior to processing incoming records. Otherwise, it would be quite costly in terms of processing time to lookup each record one at a time against a reference database residing on a data store. Conventionally, all records for a reference database are retrieved and cached to expedite processing.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described the subject innovation pertains to data caching and lookup. The conventional approach of caching all records from a reference database in advance does enable lookup to be done faster than if each record was retrieved from the reference database one by one. However, this technique requires very large amounts of memory that may or may not be available and would typically require reading in millions of records from the database. Further yet, caching all the records is wasteful as it requires looking up reading more records than necessary from a reference source and reduces the memory available for other operations, among other things. The subject innovation avoids these and other disadvantages by predicting and caching only a limited number of items that have a significant likelihood of being looked up.

In accordance with an aspect of the subject innovation, a data-mining component can be employed to determine which data items or records should be cached. More specifically, a data-mining query can be executed on or more models to predict the best records from a reference set to cache in memory to optimize the likelihood that a reference record will be found quickly and reduce unnecessary caching.

According to another aspect of the subject innovation, the data-mining component can be employed to populate at least a portion of the cache with predicted candidate values based on a context. A lookup component can subsequently interact with the cache to look up values expeditiously.

In accordance with another aspect of the subject invention, the cache can be populated iteratively. More specifically upon receipt of a data item such as a key or reference, the lookup component can query the cache. If the cache does not include the requested record or values, the data-mining component can predict or infer other items that are likely to be looked up based on the first requested item and cache the values associated with the first and predicted items.

In accordance with yet another aspect of the subject innovation, a replacement component can affect a replacement policy upon exhaustion of allocated cache based at least in part on a relevancy score provided by the data-mining component.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a data caching system.

FIG. 2 is a block diagram of a data-mining component.

FIG. 3 is a block diagram of a lookup system.

FIG. 4 is a block diagram of a lookup system in conjunction with an alternative data caching system.

FIG. 5 is a block diagram of a management component.

FIG. 6 is a flow chart diagram of a data caching methodology.

FIG. 7 is a flow chart diagram of a lookup methodology.

FIG. 8 is a flow chart diagram of a lookup methodology.

FIG. 9 is a flow chart diagram of a lookup methodology.

FIG. 10 is a schematic block diagram illustrating a suitable operating environment for aspects of the subject innovation.

FIG. 11 is a schematic block diagram of a sample-computing environment.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used in this application, the terms “component” and “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Artificial intelligence based systems or methods (e.g., explicitly and/or implicitly trained classifiers, knowledge based systems . . . ) can be employed in connection with performing inference and/or probabilistic determinations and/or statistical-based determinations in accordance with one or more aspects of the subject innovation as described infra. As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus, or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

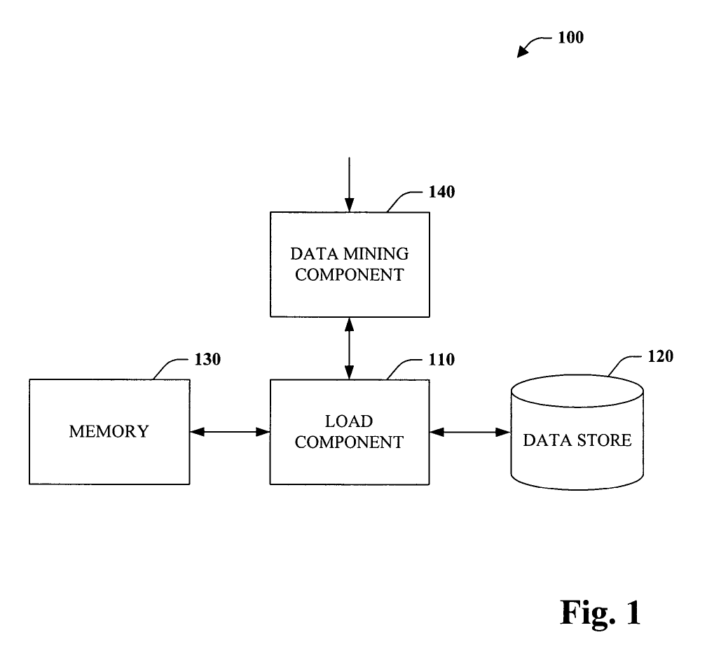

Turning initially to FIG. 1, a data caching system 100 is depicted in accordance with the subject innovation. System 100 includes a load component 110 communicatively coupled to a data store 120 and memory 130. Data store 120 can include persistent and/or bulk storage systems including but not limited to magnetic disks, optical disks, and magnetic tape. Memory 130 corresponds to devices that retain data and access their contents at higher speeds then data store 120, for example memory 130 can correspond to random access memory (RAM), read only memory (ROM), cache and the like. It should be noted that conventional memory 130 is also volatile in that data can only be retained and accessed while in use or while power is supplied thereto, unlike store 120. However, the subject innovation also encompasses non-volatile memory as well. In relation, memory 130 is higher in the memory hierarchy than store 130. Memory 130 is fasted and limited, while data store 120 is slower yet plentiful. Load component 110 can retrieve data from the store 120 and copy this data to memory 130 (also referred herein to simply as caching). In this manner, processing speed is improved as data can be accessed extremely fast in memory 120. Load component 110 is also communicatively coupled to data mining component 140.

Data mining component 140 employs data mining or knowledge discovery techniques and/or mechanisms to identify or infer (as that term is defined herein) associations, trends or patterns automatically. The data-mining component 140 can be employed to generate useful predictions about the future, thereby enabling proactive and knowledge driven decisions.

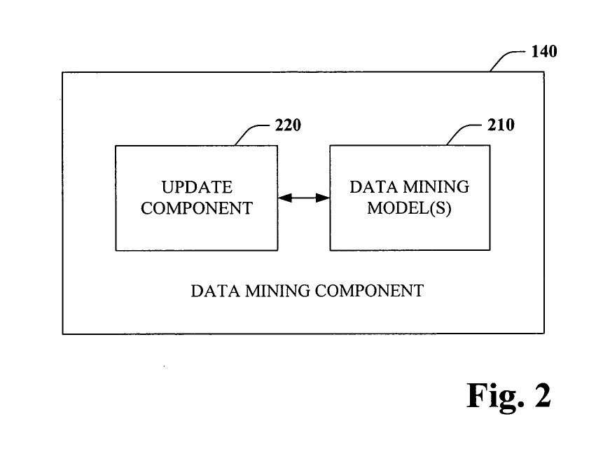

Turning briefly to FIG. 2, a data-mining component 140 is depicted in accordance with an aspect of the subject innovation. As illustrated, the data-mining component 140 can include a data mining model component 210. Data mining models 210 can be employed to among other things identify or infer associations and sequences. An association is a correlation of one event to another. A sequence identifies when one event leads to another. One or more data mining algorithms can be employed by a model including but not limited to regression (e.g., linear, non-linear, logistic . . . ), decision trees and rules, neural networks, nearest-neighbor classification, and inductive logic. Once the data-mining model 210 is a trained, for instance with historical data, the model 210 can be employed to make predictions about the future.

While a mining model 210 may be accurate as of its creation, it may need to be modified to account for data received after its creation. Update component 220 is communicatively coupled to the data mining model component 210 and facilitates updating of a data model. For example, rules or associations can be modified to reflect current trends or patterns, inter alia. Updates can be performed continuously or at predetermined time periods.

Returning to FIG. 1, the data-mining component 140 can be employed to predict or infer values that need to be cached or saved to memory 130 from store 120 based on received or retrieved context. In one instance, data mining component 140 can execute a data-mining query, such as a data mining extensions (DMX) statement based on the context. The data-mining component 140 can communicate with the load component 110 to identify one or more data items to be copied from data store 120 to.memory 130. Based on the communication with the data mining component 140, load component 110 can load retrieved identified values and copy them to memory 130 to facilitate expeditious data processing. In other words, values inferred to have a high likelihood of use can be cached.

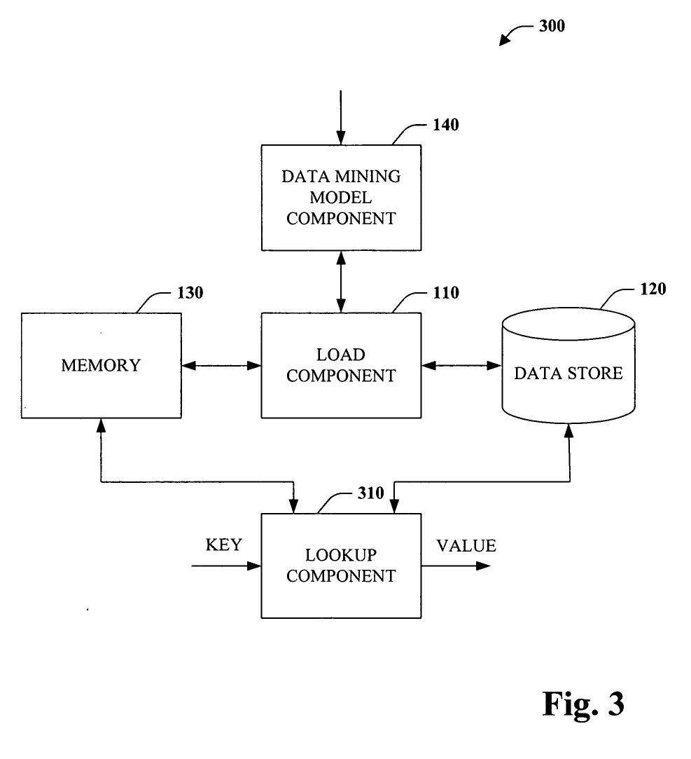

FIG. 3 illustrates a lookup system 300 in accordance with an aspect of the subject innovation. System 300 operates utilizing data caching system 100 of FIG. 1. In particular, system 300 includes a load component 110 communicatively coupled to the store component 120 and memory component 130. The load component 110 is also communicatively coupled to the data-mining component 140. The load component 110 receives, retrieves, or otherwise obtains identification of one or more values from data mining component 140. Upon receipt of the identification of these values or shortly thereafter, the load component 110 can retrieve identified values form store 120 and provide a copy for storage in memory 130.

System 300 also includes a lookup component 310 communicatively coupled to the data store 120 and memory 130. The lookup component 310 can receive, retrieve or otherwise acquire a data reference such as a key and lookup one or more values (e.g., a record) associated with that key in one or both of data store 120 and memory 130. In particular, lookup component 310 can first attempt to obtain a value associated with a key from memory 130 by executing a query thereon. If the memory 130 includes the value(s) associated with a particular reference, the value(s) can simply be output. Alternatively, if memory 130 does not include the requested data, then the lookup component can query the data store 120 for the value(s). If the value(s) are retrieved they can subsequently be output, otherwise an error can be generated. The output value can then be utilized elsewhere such as for population of a data warehouse or other data integration processes including but not limited to data cleansing and migration.

To facilitate lookup of values, it would be most efficient if the values were housed and retrieved from memory 130 rather than data store 120. Data mining component 140 can assist in this area by predicting or inferring values to be looked up by lookup component 310 and providing these values to load component 110 to copy from data store 120 to memory 130. Predictions made by data mining component 140 can be based on retrieved or received context information.

By way of example and not limitation, consider a scenario in which the lookup component 310 is to look up the names of products associated with particular SKUs (Stock Keeping Units). Looking up each value one at a time against a product reference database resident on data store 120 would be extremely costly in terms of processing time. Caching all the values from the product reference database in advance would make the lookup faster, but would require a very large amount of memory that might not be available and could also require reading in millions of records from the data store 120. Furthermore, caching all the values is wasteful, firstly because some products will be seasonal and not likely to be found every time the incoming data is processed. Secondly, even without seasonality not all the products stocked by a store will be sold each processing period (e.g., day).

System 300 produces a more efficient lookup approach. For example, data mining component 140 can receive a date in December as context data. Based on this information, data mining component 140 can predict values that will be looked up by lookup component 110. For example, eggnog, Christmas decorations, candy canes, and the like could be included. In contrast, other products such as pumpkins, apple cider, and Halloween decorations could be excluded. Additionally, items could be excluded based on historical data indicating that such items have not been purchased on the particular day in December. Accordingly, the data-mining component 140 identifies a number products that are most likely to be looked up on the given day to the load component 110. The load component 110 can then copy those values or records from the data store 120 to the memory 130. The number of actual values can be dependent upon the size of the memory 130, the allocated portion and/or availability thereof. Subsequently, when a myriad of SKUs are received or retrieve lookup component 310 can provide the values expeditiously as they are likely to reside in the memory 130. Furthermore, not all records are cached wastefully, and although a few values may need to be looked up from the data store 120 from time to time, the vast majority of values will be able to be retrieved directly from the memory 130 thereby improving the processing speed of the lookup component 310.

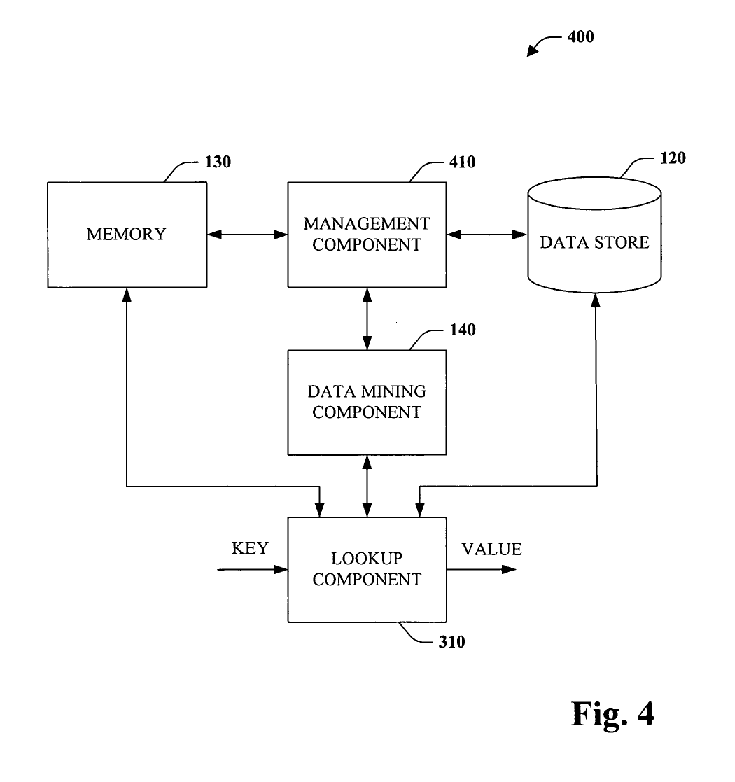

FIG. 4 illustrates a lookup system 400 in accordance with an aspect of the subject innovation. Lookup system 400 includes a lookup component 310 communicatively coupled to both data store 120 and memory 130. Lookup component 310 receives a reference or key and returns one or more values or a record associated with the key. In particular, lookup component can first query memory 130 to determine if the value is resident therein. If so, the value is copied and returned. If not, the look up component 310 can directly or indirectly effectuate a query of data store 120 and return the value if present of alternatively generate an error. In addition, the lookup component 310 can communicate the reference and/or the value that required retrieval from the data store 120 to the data-mining component 140. As previously described, the data-mining component 140 can identify or infer predicted candidate references or values that are likely to be looked up. In this case, the data-mining component 140 can make predictions based on the identity of the reference and/or value provided by the lookup component 310, among other things. Consider a supermarket example in which SKUs are matched to products. If the value or product corresponds to eggs, then the data mining component 140 may identify bacon and hash browns, among other things, as other products and/or references thereto that should be cached due to their relationship or a trend. The data-mining component 140 can provide the identification of references to the management component 410. Furthermore, it should be appreciated that data-mining component 140 may also pass generated relevancy scores to the management component 410.

Management component 410 manages the contents of memory 130. Management component 410 is communicatively coupled to the data-mining component 140 and thus receives, retrieves or otherwise obtains or acquires information from the data-mining component 140. In particular, the management component 140 can receive identification of predicted references to be cached. Furthermore, the management component 410 may receive a value associated with the value looked up from the data store 120 by look up component 110. The management component 410 can then retrieve the values associated with the references identified by data mining component 140 from the data store 140 and load them as well as the provided value to memory 130. In the supermarket example, now if the customer bought related items, they could be found in memory without another time intensive data store query. Similarly, if another customer also bought related items, they will also be found in memory 130.

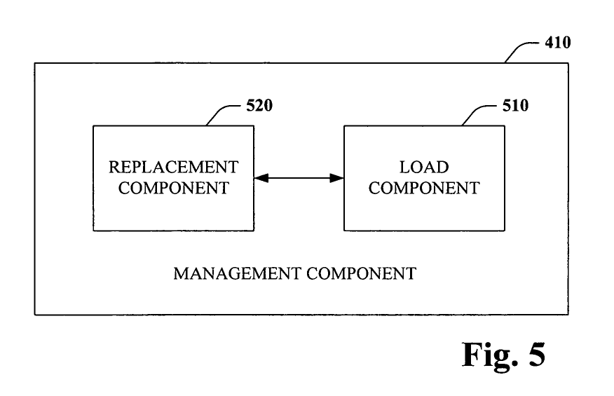

Turning to FIG. 5, a management component 410 is illustrated in accordance with an aspect of the subject innovation. The management component 410 includes a load component 510 and a replacement component 520. Load component 510 provides the mechanism to allow the management component 410 to load or cache data housed in data store 120 to memory 130. Based on the references provided to the load component 510, values can be retrieved from data store 120 and a copy stored in memory 130. Initially, incrementally or iteratively loading the memory 130 with values corresponding to identified and predicted references may proceed without problem. However, once the memory 130 or allocated portion thereof is full decisions must be made and action taken in accordance therewith. These decisions can be made or facilitated by replacement component 520.

The replacement component 520 is communicatively coupled to the load component 510. The replacement component 520 can provide an address or location for copying of data to the load component 510. Furthermore, the replacement component 520 can monitor memory 130 to identify if and when memory 130 or an allocated portion thereof will be exhausted. Once determined, replacement component 520 can identify data to be replaced, if any, by new data to be loaded by load component 510. These determinations can correspond to one or more policies implemented by the replacement component 520 to maximize the hit ratio or the number of requests that can be retrieved directly from memory 130 rather then from the slower data store 120. One simple policy that could be implemented by replacement component 520 could be based on temporal proximity. In other words, a least recently used (LRU) algorithm can be employed to replace the oldest values in terms of time with more recent values. Another approach may be to replace the least frequently used (LFU) values or some combination of LFU and LRU. Further yet, because data items can be associated with a predicted relevancy value as provided by data mining component 140 (FIG. 4), this score can also be employed by the replacement component 520 to maximize the hit ratio. It should be appreciated that what has been described here are only a few of the possible replacement policies and/or algorithms that can be implemented by the replacement component 520, others as well as hybrids are also possible and are to be considered within the scope of the subject innovation. Upon determining items to be replaced, the replacement component 520 can provide one or more addresses to load component 510.

Returning briefly to FIG. 4, it should be noted that while lookup component 310 can directly query the data store 310, it could also do so indirectly. In particular, by providing the a reference not resident in memory 120 to data mining component 140 and subsequently management component 410 the value of the reference can be retrieved from data store 120 along with other relevant values. In addition to caching the values to memory 130, management component 410 could also provide the value of the initial reference back to the lookup component 110 directly (not shown) or back through the data pipeline defined by management component 410 and data mining component 140. In this manner, the value is not looked up twice, namely once by the lookup component 110 and then by the management component 410 or more specifically load component 510. However, the subject innovation is not limited thereto and can support the double lookup.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

Furthermore, as will be appreciated, various portions of the disclosed systems above and methods below may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, data mining component 140 can employ such mechanism or methods to facilitate, among other things, identification of knowledge, trends, patterns, or associations.

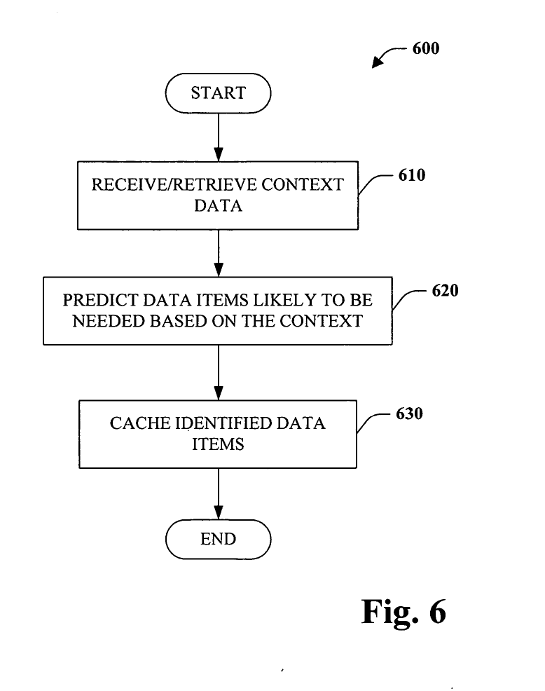

In view of the exemplary systems described supra, methodologies that may be implemented in accordance with the disclosed subject matter will be better appreciated with reference to the flow charts of FIGS. 6-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning to FIG. 6, a method 600 of caching data is illustrated in accordance with an aspect of the subject innovation. At reference numeral 610, context data can be received or retrieved. By way of example, context information could include reference to a particular database and/or a date, amongst other things providing insight into surrounding circumstances. At numeral 620, data items likely to be needed are predicted based on the context. For instance, a data mining or prediction query can be executed on a data-mining model. The prediction query can create a prediction for new data using one or more mining models. By way of example and not limitation, a prediction query may predict how many sailboats are likely to sell during the summer months or generate a list of prospective customers who are likely to buy a sailboat. At reference numeral 630, the identified items are cached or copied to memory to enable expeditious retrieval thereof. In accordance with one aspect of the subject innovation, the entire memory or an allocated portion can be populated with data items based on the given context. In this manner, the most relevant data items or records are cached in advance of processing such as for data lookup. However, the subject innovation is not limited thereto.

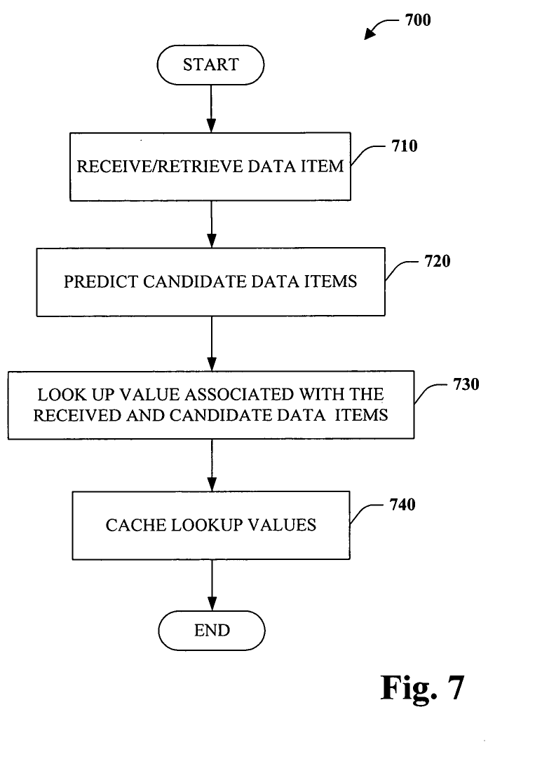

FIG. 7 illustrates a flow chart diagram depicting a lookup method 700 in accordance with an aspect of the claimed subject matter. At reference numeral 710, a data item is received or retrieved. For example, the data item can be a database key or other unique identifier. At 720, candidate data items are predicted. Candidate data items are related or associated in some manner to the received data item. In particular, data mining techniques can be utilized to infer such candidate data items based on identified patterns, trends, associations, relations, affinities and the like. At reference numeral 730, the values associated with the received item and all predicted candidate items are retrieved, for example from a data store. Finally, at numeral 740, the received values and reference items (e.g., record) are cached for example in memory to facilitate expeditious lookup.

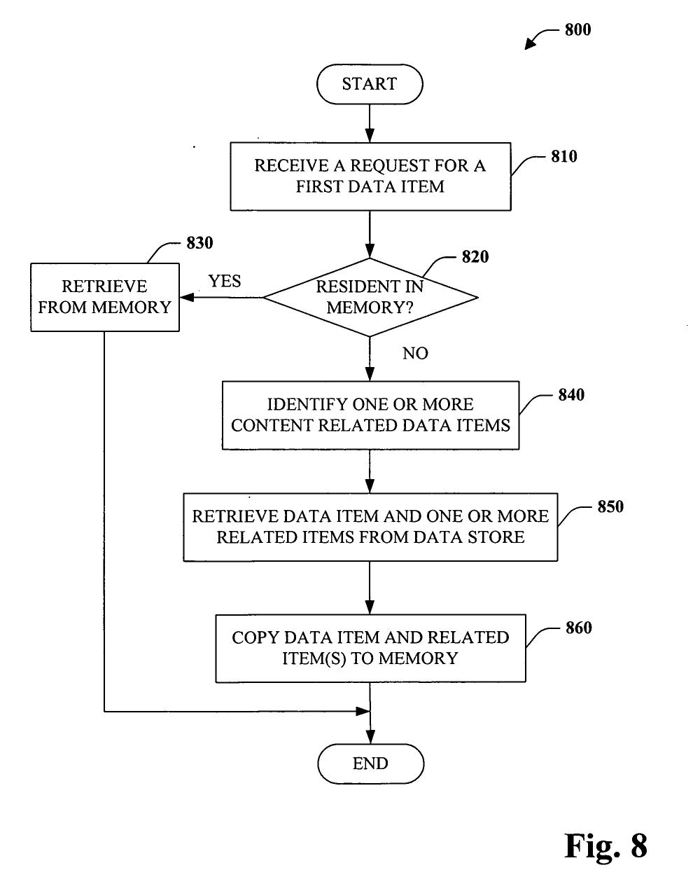

FIG. 8 illustrates a lookup methodology 800 in accordance with an aspect of the subject innovation. At reference numeral 810, a request is received for a first data item. The request may take the form of a database key, reference or the like.

At numeral 820, a check is made to determine whether the desired value or values referenced are resident in the memory or cache. If yes, the value is resident in memory, then the method proceeds to numeral 830. At reference numeral 830, a value or values (e.g., housed in a record) are retrieved from memory and the method subsequently terminates. However, if at 820 it is determined that the value or values are not resident in memory then the method continues at 840. At reference 840, one or more content related items are identified. This items can be related or some how associated with the first data item received for lookup. For instance, a data-mining query (e.g., DMX statement) can be executed on a trained mining model to identify related items and predict items that will be looked up in the future. At reference numeral 850, the value(s) associated with the first received data item and the related or predicted items are retrieved from a data store. The data and related data items as well as the retrieved values thereof are copied to memory at 860. Subsequently, the method terminates.

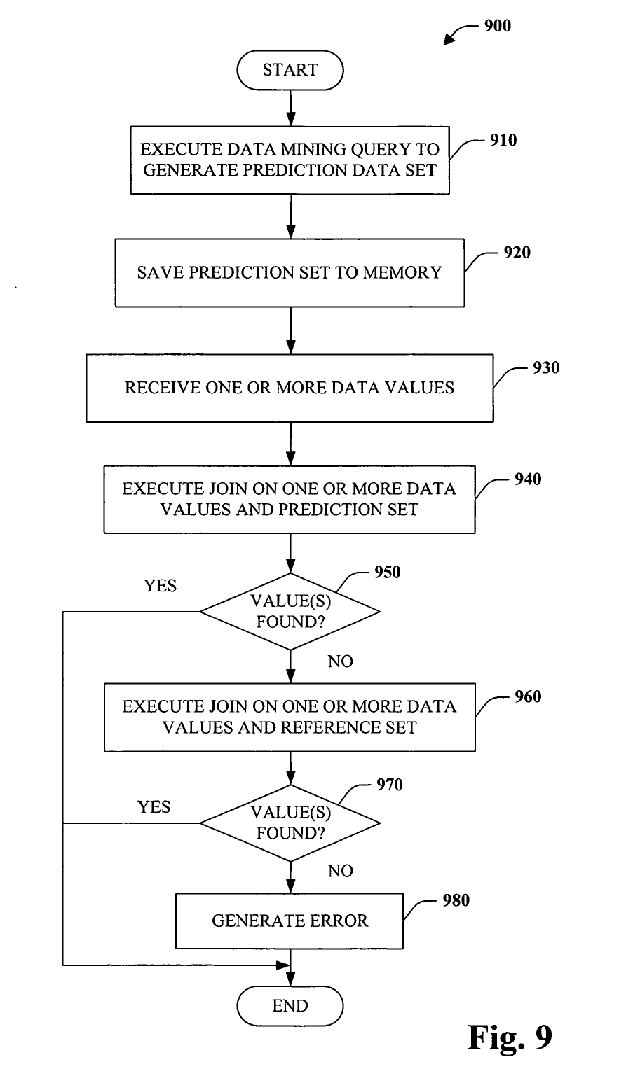

FIG. 9 is a flow chart diagram depicting a lookup methodology 900 in accordance with an aspect of the subject innovation. At reference numeral 910, a data-mining query is executed on a model to produce a prediction data set. For example, the query can correspond to a DMX (Data Mining Extensions) statement, which is an extension of the SQL (Structured Query Language) that provides support for working with mining models. At numeral 920, the prediction data set is saved to memory. One more data values including but not limited to keys are received at 930. At reference numeral 940, a join is executed on the one or more received data values and the prediction data set. At 950, a determination is made as to whether the value(s) were found. If yes, the method terminates. If no, the method proceeds to 960 where a join is executed between the unfound value(s) and a reference data set housed in a data store. At 970, another check is made to determine whether the value(s) were located. If yes, then the method terminates successfully. If no, the method continues at 980 where an error is generated. The method subsequently terminates.

The following is an example that is presented for purposes of clarity and understanding and not limitation on the scope of the claimed subject matter. Consider a lookup method that is employed to match SKUs and products for a supermarket for instance to populate a data warehouse. A first SKU can be passed as a parameter to the data-mining query. Based on a selected data-mining model, the query predicts or infers other SKUs that are likely to be found in a market basket. For instance, customers you bought coffee are also likely to buy milk and sugar. The reference data for the incoming SKU can be looked up and that value as well as the values of all SKUs predicted to be related are cached. Now if a customer has purchased related items they will be found in memory. Similarly, if another customer has also bought related items, they will also be found in memory cache rather than requiring a time intensive query of product reference data located in a data store. Of course, an error can be generated if the values are not found in either the memory or the data store.

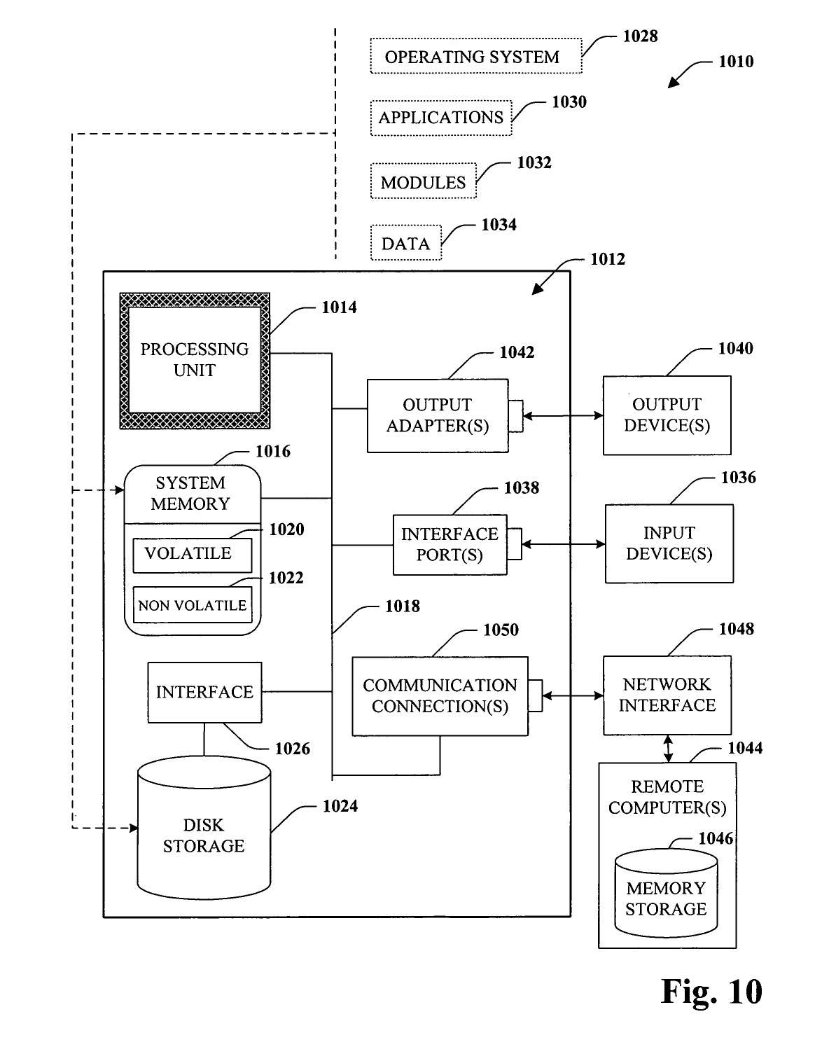

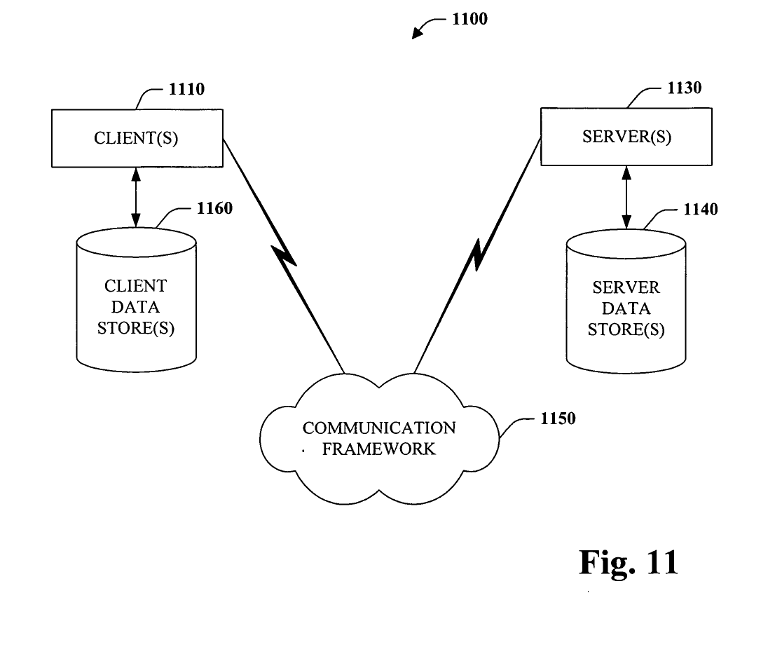

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 10, an exemplary environment 1010 for implementing various aspects disclosed herein includes a computer 1012 (e.g., desktop, laptop, server, hand held, programmable consumer or industrial electronics . . . ). The computer 1012 includes a processing unit 1014, a system memory 1016, and a system bus 1018. The system bus 1018 couples system components including, but not limited to, the system memory 1016 to the processing unit 1014. The processing unit 1014 can be any of various available microprocessors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the present invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like displays (e.g., flat panel and CRT), speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1016, it can also be external to computer 1012. The hardware/software necessary for connection to the network interface 1048 includes, for exemplary purposes only, internal and external technologies such as, modems including regular telephone grade modems, cable modems, power modems and DSL modems, ISDN adapters, and Ethernet cards or components.

FIG. 11 is a schematic block diagram of a sample-computing environment 1100 with which the subject innovation can interact. The system 1100 includes one or more client(s) 1110. The client(s) 1110 can be hardware and/or software (e.g., threads, processes, computing devices). The system 1100 also includes one or more server(s) 1130. Thus, system 1100 can correspond to a two-tier client server model or a multi-tier model (e.g., client, middle tier server, data server), amongst other models. The server(s) 1130 can also be hardware and/or software (e.g., threads, processes, computing devices). The servers 1130 can house threads to perform transformations by employing the subject innovation, for example. One possible communication between a client 1110 and a server 1130 may be in the form of a data packet transmitted between two or more computer processes.

The system 1100 includes a communication framework 1150 that can be employed to facilitate communications between the client(s) 1110 and the server(s) 1130. The client(s) 1110 are operatively connected to one or more client data store(s) 1160 that can be employed to store information local to the client(s) 1110. Similarly, the server(s) 1130 are operatively connected to one or more server data store(s) 1140 that can be employed to store information local to the servers 1130.

What has been described above includes examples of aspects of the claimed subject matter. It is, of course, not possible to describe every conceivable combination of components or methodologies for purposes of describing the claimed suject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A data caching system comprising the following computer implemented components:
a data mining component that generates a prediction data set; and
a load component that loads a copy of the prediction data set into memory.

2. The system of claim 1, further comprising a lookup component that receives or retrieves a reference and looks up a value associated with that reference in the memory.

3. The system of claim 2, the lookup component looks up the value associated with the reference in a data store, if it is not located in the memory.

4. The system of claim 1, the data-mining component generates the prediction data set based upon received and/or retrieved context information.

5. The system of claim 1, the data-mining component generates the prediction data set via execution of a query on a data-mining model.

6. The system of claim 5, the query is a data mining extensions (DMX) statement.

7. The system of claim 5, further comprising an update component that updates the data-mining model to improve the accuracy thereof based on additional data.

8. The system of claim 1, further comprising a replacement component that facilitates replacement of data in memory with a copy of data persisted in data store based at least in part upon a relevancy score provided by the data-mining component.

9. A data processing methodology comprising the following computer implemented acts:
executing a data mining algorithm to infer candidate lookup values; and
caching the values in memory.

10. The method of claim 9, further comprising looking up values in memory.

11. The method of claim 10, looking up values in memory prior to caching the values.

12. The method of claim 10, further comprising fetching values from a data store if the values are not located in memory.

13. The method of claim 12, further comprising generating an error if the value is unable to be fetched from the data store.

14. The method of claim 13, further comprising populating a data warehouse with the looked-up values.

15. The method of claim 9, further comprising receiving a data mining extensions (DMX) statement to initiate data mining algorithm execution.

16. A lookup method comprising the following computer implemented acts:
receiving a primary reference for lookup;
inferring one or more secondary references likely to be looked up based on the primary reference and a data-mining model;
retrieving values for the primary and secondary references from a data store; and
caching the primary and secondary references and values associated therewith in memory.

17. The method of claim 16, retrieving the values comprises executing a join operation on the primary and secondary references and a stored reference data set.

18. The method of claim 16, inferring one or more secondary references comprises executing a prediction query on the data-mining model.

19. The method of claim 16, further comprising querying the memory for the value of the primary reference prior to performing the other acts and retrieving the value if resident in memory.

20. The method of claim 16, further comprising populating a data warehouse with one or both of the primary reference and the value thereof.
